(19) United States
(12) Patent Application Publication
(10) Pub. No.: US 2009/0128321 A1
(43) Pub. Date: May 21, 2009

(54) HOME APPLIANCE WITH SECURITY FUNCTION

(76) Inventor: Mi Kyung HA, Changwon-si (KR)

Correspondence Address: KED & ASSOCIATES, LLP, P.O. Box 221200, Chantilly, VA, 20153-1200, US

(21) Appl. No.: 12/255,004

(22) Filed: Oct. 21, 2008

(30) Foreign Application Priority Data
Oct. 23, 2007 (KR) 10-2007-0106469

(51) Int. Cl. G08B 19/00

(52) U.S. Cl. 340/521

(57) ABSTRACT

A home appliance with a security function is disclosed which is capable of performing a security function, using a security sensor or security control part provided therein. According to the home appliance with the security function described above, a security function may be performable without additional equipments or cost. Furthermore, a security sensor may be installed in various methods according to characteristics of a security object place or space, such that various security functions may be performable. A still further, even if a manager of a security object place is not available, the SMS transmission function of the home appliance with the security function described above may make possible the security of the security object place.

### CROSS REFERENCE TO RELATED APPLICATION

This application claims the benefit of the Patent Korean Application No. 10-2007-0106469, filed on Oct. 23, 2007, which is/are hereby incorporated by reference as if fully set forth herein.

### BACKGROUND OF THE DISCLOSURE

1. Field of the Disclosure

The present invention relates to a home appliance with a security function. More particularly, the present invention relates to a home appliance capable of performing a security function, using a security sensor and security control part provided therein.

2. Discussion of the Related Art

The present invention relates to a home appliance having a security function. Recently, haven been released a lot multipurpose home appliances with various functions rather than original functions.

First of all, a general method of performing a security function in a building will be described.

A security company is entrusted and various kinds of sensors are installed in a predetermined space which is a security object. In addition, a control part connected with a communication network of the security company is installed. Then, if any dangerous situations occur, one or more security guard(s) may be called out.

However, typically the method of entrusting the security company with security costs quite a lot and there are some areas which are difficult for the security company to be sent to.

Moreover, a home networking system provided when building a new apartment is in communication with a guardroom in an apartment complex to perform a security function. Here, there might be a limit of security in a newly-built apartment or in just the security function of the communication with the guardroom.

A door lock system in that a user should press a secret access number to open a door provides a kind of security function of alarming if the door is opened abnormally or an external shock is applied to the door. However, that function of the door lock system is not enough.

A security function is provided in a conventional home appliance according to the present invention. Without any auxiliary equipments or cost, security dangerous situations which might occur in home may be prevented. In addition, the home appliance according to this specification is invented to provide a security function capable of informing a manager, who is out of the security object space, of a state of the house.

### SUMMARY OF THE DISCLOSURE

Accordingly, the present invention is directed to a home appliance with a security function.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a home appliance with a security function includes a security sensor sensing a security signal; a security control part determining whether the security signal sensed by the security sensor is corresponding to a security-danger situation, the security control part controlling the security function; and a warning-signal generation device controlled by the security control part.

The waning signal generation device may be a warning sound generation device which generates a warning sound corresponding to the security-danger situation.

The warning-signal generation device may be a display device which displays the security-danger situation.

The warning-signal generation device may be a SMS circuit which converts the signal transmitted by the security control part to a SMS packet to transmit SMS to at least one registered telephone number or which receives a SMS packet from a telephone wire to transmit the received SMS packet to the security control part. At this time, the SMS circuit may be controlled by the security control part, being connected with a wire telephone network.

The received SMS packet may be an on-off signal of the security function and the security control part turns on and off the security function according to the received SMS packet.

The security sensor may be provided in plural and the security sensor may be one of an infrared sensor, thermo-sensor, door-opening sensor and shock sensor.

The home appliance may be a laundry apparatus.

The security sensor may be installed outside a body of the home appliance, the security sensor being connected with the security control part via wire or wireless technology.

In another aspect, a control method of a home appliance with a security function includes sensing a security signal sensed by a security sensor; determining whether the sensed security signal is corresponding to a security-danger situation; and generating a warning-signal corresponding to the security-danger situation, if it is determined that the security-danger situation occurs.

The security sensor sensing the security signal in the sensing of the security signal may be provided in plural and the security sensor may be one of an infrared sensor, thermo-sensor, door-opening sensor and shock sensor.

The sensing of the security signal and the determining whether sensed security signal is corresponding to the security-danger situation may be repeated at a preset time period.

The generating of the warning-signal may be performed by a warning sound generation device generating a warning sound corresponding to the security-danger situation, a display device displaying the security-danger situation or a SMS circuit transmitting SMS.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a conceptual diagram of a home appliance with a security function according to an exemplary embodiment; and

FIG. 2 is a diagram illustrating an operation of the home appliance with a security function according to the exemplary embodiment.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

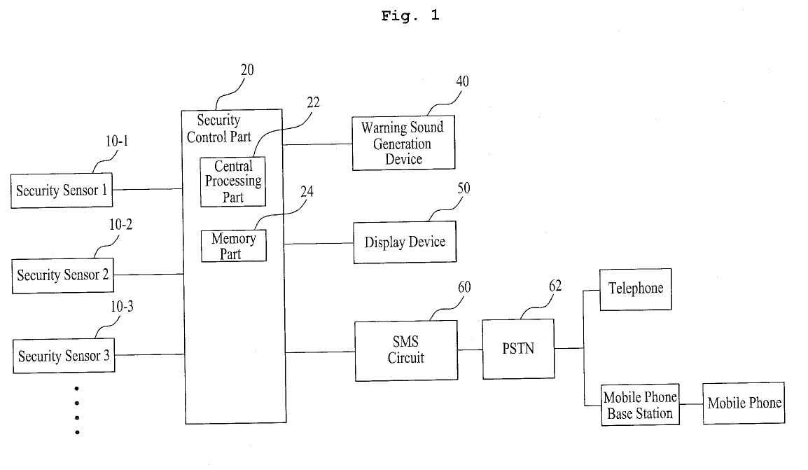

FIG. 1 is a conceptual diagram of a home appliance with a security function according to an exemplary embodiment.

The home appliance with a security function according to an exemplary embodiment includes a security control part 20 performing the security function.

Here, the security function is referenced to as a function of creating a warning sound, displaying a security-danger situation or transmitting SMS, using a warning sound generation device, a display device or a SMS circuit, respectively, for example.

The security control part 20 collects information relating security via a security sensor 10 installed in a security object space. From now on, the signal relating to security which is sensed by the sensor will be referenced to as a security signal. The security signal may be classified based on its security degree into a signal corresponding to a security-danger situation and a signal corresponding to non-security-danger situation.

Such the classification may be variable according to sensitivity of the security sensor.

Here, the security sensor 10 may be installed in the home appliance with a security function according to the present invention or it may be installed outside the home appliance, being connected with the security control part 20 via wire or wireless technology.

In addition, identical kinds of sensors may be provided in the home appliance with a security function as the security sensor or various kinds of sensors may be provided in the home appliance with a security function. A plurality of security sensors (10-1, 10-2, 10-3 . . . and 10-N) shown in FIG. 1 may be provided to send various security signals.

If the security sensor 10 is installed in a body of the home appliance, the security control part 20 could be adjacent to the security sensor 10. From now on, a case will be described in that the security control part 20 is separate from the security sensor 10.

Also, it is possible that a home appliance including the security control part 20 should be positioned in a different space from space where the security sensor is installed.

Here, the kinds of the sensors which can be useable as the security sensor 10 include an infrared sensor, a thermo-sensor, a door-open sensor and a shock sensor.

The infrared sensor senses a physical value such as strength of temperatures, pressure or infrared rays or a chemical value by using infrared rays and it converts the sensed value into an electric value which is able to be processed into a signal. The infrared sensor may emit infrared rays to sense whether the infrared rays are shut off or it may detect ambient infrared rays.

The heat sensor, the door-open sensor and the shock sensor may also sense a heat element, opening of a door and shock, respectively, and they convert the heat element, the opening of the door and the shock into an electric signal to transmit the converted signal to the security control part 20 of the home appliance with the security function, as well as the infrared sensor.

The infrared sensor and the thermo-sensor may be useable not only for security but also fire protection. The sensors can sense temperature changes rather than heat elements in the security object space where the sensor is installed.

To transmit the security signal sensed by the security sensor 10 to the security control part 20, the security sensor 10 should be electrically connected with the security control part 20.

Here, it is preferable that the security sensor 10 is connected with the security control part 20 by a cable including a wire.

If an infrared data communication module or Bluetooth module may be provided in both the security sensor 10 and the security control part 20 for radio communication, the security sensor 10 can exchange information with the security control part 20 via radio communication, in addition to connecting the security sensor 10 with the security control part 20 by a wire.

The security control part 20 determines whether the transmitted signal is corresponding to a security-danger situation and transmits a corresponding warning-signal generation command to the warning-signal generation device.

According to the embodiment shown in FIG. 1, the warning-signal generation device may be a warning sound generation device 40, a display device 50 or a SMS circuit 60. As a result, the security control part 20 may transmit a warning sound generation command, display command or a SMS transmission command correspondingly.

The information transmitted from the security control part 20 to the warning sound generation device 40, the display device 50 or the a SMS transmission device 60 may be preset to generate various steps of warning sound generation, display or a SMS transmission commands according to grades of the security-danger situation.

That is, the security control part 20 classifies security-danger situations according to security signals sensed by the security sensor 10 and generates corresponding commands.

The warning sound generation device 40 generates a stored warning sound via a speaker installed outside the home appliance according to the warning sound generation command transmitted by the security control part 20.

It is preferable that various kinds of warning sounds are stored according to the warning sound generation command.

As mentioned above, if the security signal sensed by the infrared sensor or the thermo-sensor is corresponding to a security-danger situation such as a stranger-break-in or a fire, the warning sound may include an alarm or voice which the nearest manger can identify. Also, the warning sound generation device may have a grade of volumes preset by the user.

The security control part 20 determines whether the security signal sensed by the security sensor 20 is corresponding to a security-danger situation and generates a corresponding display. Then, the contents corresponding to the display command is displayed at the display device 50.

The display device 50 may an auxiliary structural element of the warning sound generation device 40. For example, if the home appliance with the security function is installed indoor and the security sensor 10 connected with the security control part 20 is installed in another separate place, the user identifies and deals with a security-danger situation based on the warning sound generated from the warning sound generation device 40 and the information displayed at the display device 50.

On the other hand, the security control part 20 is connected a wire telephone network, by extension, with a SMS circuit 60 which generates SMS (Short Message Service). Then, the SMS circuit 60 packetizes messages in text corresponding to the SMS transmission command transmitted from the security control part 20 and it transmits the SMS-packetized messages to the user via the wire telephone network.

The wire telephone is connected with Public Switched Telephone Network (PSTN) and the SMS packet is transmitted to the user's a mobile phone via the PSTN.

The characters stored in the SMS circuit correspondingly to each security-danger situation may be converted to a SMS packet according to the SMS transmission command of the security control part 20 and the SMS packet is transmitted to the user's mobile phone. Those stored characters include the user's address, for example, and they may be information such as “stranger-break-in” or “fire occurs”. That is, the character information may be more specified variably according to the kind of the sensor.

At least one private telephone number may be stored in the SMS circuit 60. Here, the telephone number may be stored in the SMS circuit 60 by the security control part 20. As a result, the home appliance according to the present embodiment may include an operation input part 70 which is used in storing information, such as registering a telephone number and user preset, by the user.

The operation input part 70 may be used if the user selects the set-ups needed to perform the security function and it may be provided separately for the security function or auxiliary in an input part which controls original functions of the home appliance.

In the meantime, at least two telephone numbers may be stored in the security control part 20. Recently, the report to the police or sending of a SOS call may be performed by the SMS transmission. Corresponding to each of the security-danger situations, the characters of “fire occurs” or “stranger breaks-in” may be transmitted to a fire or police station rather than the manager of the security object place.

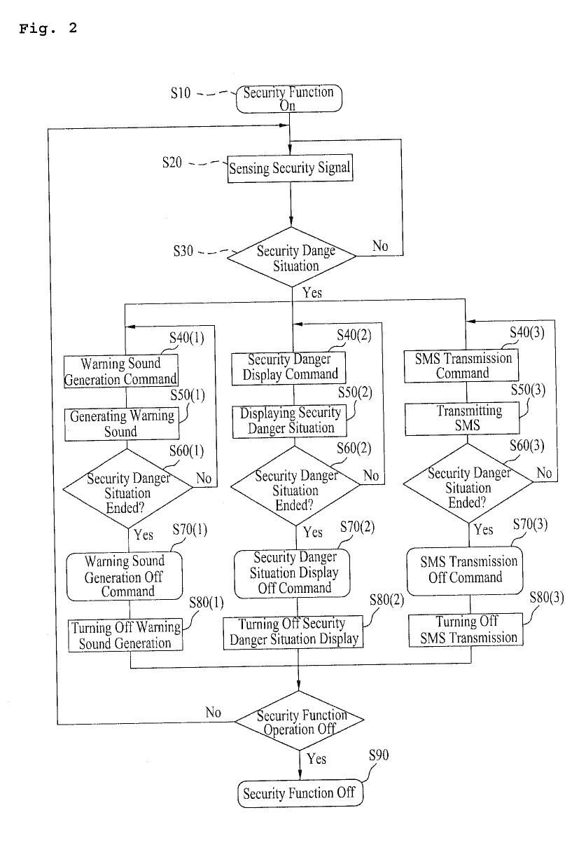

FIG. 2 is a diagram illustrating an operation of the security function according to the exemplary embodiment.

A control method of a home appliance with a security function may include sensing a security signal by using a security sensor (S20); determining whether the sensed security signal is corresponding to a preset security-danger situation (S30); generating a warning-signal corresponding to the security-danger situation, if it is determined that the security-danger situation occurs (S50).

The home appliance with the security function operates the security function selectively.

The turning on of the security function (S10) is performed by a user. To perform the step S10, a security switch (not shown) provided at a control panel of the home appliance is switched on.

There are independently provided an operational control part performing original functions of the home appliance and a security control part. At this time, it is preferable that the operational control part and the security control part are operated separately. As a result, even if the home appliance is turned off, the security function may be operable separately.

The sensing of the security signal (S20) is performed by the security sensor 10. As mentioned above, the security control part may be provided in plural and the security control part may be one of the infrared sensor, thermo-sensor, door-opening sensor and shock sensor.

The sensing of the security signal (S20) and the determining whether the sensed security signal is corresponding to the security-danger situation (S30) may be repeated at a preset time period.

The security sensor 10 senses changes of the place where it is installed and the security sensor 10 transmits the sensed changes to the security control part 20. If the security sensor 10 transmits all of the sensible security signals to the security control part 20, the security control part 20 determines whether the security signals are corresponding to security-danger situations to determine whether the security-danger situation occurs (S30).

According to the kind and sensitivity of each security sensor 10, the security signal sensed by the security sensor 10 may be variable. It is preferable that it is programmed in the security control part 20 whether the security signal is corresponding to the security-danger situation.

A Memory part 24 of the security control part 20 is a kind of area where a security control program operated in a central processing part of the security control part 20 and user's set-ups are stored. It is stored in the Memory part 24 whether the security signal is corresponding to the security-danger situation and also stored in the security control program operated in the central processing part 22 of the security control part 20.

In the generating of the warning-signal corresponding to the security-danger situation, if it is determined that the security-danger situation occurs (S50), a warning sound corresponding to the sensed security-danger situation is generated by the warning sound generation device (S50(1)) or the security-danger situation is displayed via the display device (S50(2)) or security-danger situation SMS is performed via the SMS circuit provided in the home appliance (S50(3)).

If the security signal sensed in the determining of the security-danger situation (S30) is corresponding to the security-danger situation, the security control part 20 transmits a warning sound generation command, display command or SMS transmission command to the warning sound generation device 40, display device 50 or SMS circuit 60. according to the warning sound generation command, display command or SMS transmission command, respectively, the warning sound generation device 40 generates the warning sound (S50(1)), the display device 50 displays the security danger (S50(2)) or the SMS circuit 60 SMS packetizes the characters transmitted by the security control part 20 together with the SMS transmission command to send the SMS packet to the user via the PSTN connected with the SMS circuit 60 (S50(3)).

It is preferable that the SMS circuit 60 is security-control programmed to transmit the characters at a preset time period continuously, if the security-danger situation is not handled. Here, the frequency of the SMS transmission may be determined by the user selection.

The SMS circuit 60 transmits the characters corresponding to the SMS transmission command of the security control part 20. In reverse, the SMS circuit 60 may receive characters transmitted via the PSTN and it may transmit the received characters to the security control part 20.

For example, the manager who is not available the security object place may transmit characters to the number registered to the home appliance with the security function to control the security function to be on and off.

During the above process, the security sensor 10 senses and transmits the security signal continuously to the security control part 20. The security control part 20 continuously compares the received security signal with the security-danger situation correspondingly (S60).

It is performed separately based on a security signal transmitted by the each of the security sensors whether the control of the security-danger situation is removed.

If it is determined that the security signal transmitted by the security sensor 10 is not corresponding to the security-danger situation, the security control part 20 transmits a warning-sound-off command to the warning sound generation device 40, a security-danger-display-off command to the display device 50 or a SMS-transmission-off command to the SMS circuit 60 (S70(3)). The SMS circuit 60 which has received the SMS-transmission-off command (S70(3)) stops the SMS transmission.

In the above process may be performed the security function. If the security-danger situation is handled, the security sensor 10 returns to a standby mode, sensing a security signal.

At this time, if the control of the security-danger situation is removed and the security function is turned off by the user, the security function is stopped (S(90)).

Therefore, according to the home appliance with the security function described above, a security function may be performable without additional equipments or cost.

Furthermore, a security sensor may be installed in various methods according to characteristics of a security object place or space, such that various security functions may be performable.

A still further, even if a manager of a security object place is not available, the SMS transmission function of the home appliance with the security function described above may make possible the security of the security object place.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A home appliance with a security function comprising:
a security sensor sensing a security signal;
a security control part determining whether the security signal sensed by the security sensor is corresponding to a security-danger situation, the security control part controlling the security function; and
a warning-signal generation device generating a warning-signal corresponding to the security-danger situation, the warning-signal generation device controlled by the security control part.

2. The home appliance with the security function of claim 1, wherein the waning signal generation device is a warning sound generation device which generates a warning sound corresponding to the security-danger situation.

3. The home appliance with the security function of claim 1, wherein the warning-signal generation device is a display device which displays the security-danger situation.

4. The home appliance with the security function of claim 1, wherein the warning-signal generation device is a SMS circuit which converts the signal transmitted by the security control part to a SMS packet to transmit SMS to at least one registered telephone number or which receives a SMS packet from a public switched telephone network to transmit the received SMS packet to the security control part, the SMS circuit controlled by the security control part, connected with a public switched telephone network.

5. The home appliance with the security function of claim 4, wherein the received SMS packet is an on-off signal of the security function and the security control part turns on and off the security function according to the received SMS packet.

6. The home appliance with the security function of claim 1, wherein the security sensor is provided in plural and the security sensor may be one of an infrared sensor, thermo-sensor, door-opening sensor and shock sensor.

7. The home appliance with the security function of claim 5, wherein the home appliance is a laundry apparatus.

8. The home appliance with the security function of claim 1, wherein the security sensor is installed outside a body of the home appliance, the security sensor being connected with the security control part via public switched telephone network or wireless network.

9. The home appliance with the security function of claim 8, wherein the security sensor is installed outside a body of the home appliance, the security sensor being connected with the security control part via public switched telephone network or wireless network.

10. A control method of a home appliance with a security function comprising:
sensing a security signal sensed by a security sensor;
determining whether the sensed security signal is corresponding to a security-danger situation; and
generating a warning-signal corresponding to the security-danger situation, if it is determined that the security-danger situation occurs.

11. The control method of claim 10, wherein the security sensor sensing the security signal in the sensing of the security signal is provided in plural and the security sensor may be one of an infrared sensor, thermo-sensor, door-opening sensor and shock sensor.

12. The control method of claim 10, wherein the sensing of the security signal and the determining whether sensed security signal is corresponding to the security-danger situation are repeated at a preset time period.

13. The control method of claim 10, wherein the generating of the warning-signal is performed by a warning sound generation device generating a warning sound corresponding to the security-danger situation, a display device displaying the security-danger situation or a SMS circuit transmitting SMS.
